(19) United States
(12) Patent Application Publication
(10) Pub. No.: US 2025/0260992 A1
(43) Pub. Date: Aug. 14, 2025

(54) METHODS AND SYSTEMS FOR PROOF OF LOCATION PRIOR TO ACTION PERMISSION

(71) Applicant: Shopify Inc., Ottawa (CA)

(72) Inventors: Pedro Luis Teruel Giménez, London (GB); Juan Jose Guerrero Lozano, London (GB); Samuel William Giles, Somerset (GB); Francisco Jose Rios Bello, Sevilla (ES)

(21) Appl. No.: 18/734,801

(22) Filed: Jun. 5, 2024

Related U.S. Application Data
(60) Provisional application No. 63/552,819, filed on Feb. 13, 2024.

(51) Int. Cl. H04W 12/63; H04W 12/06

(52) U.S. Cl. CPC H04W 12/63; H04W 12/068

(57) ABSTRACT

A computer method including sending a location challenge to a mobile computing device, the location challenge identifying a radio beacon; receiving a location challenge response from the mobile computing device, the location challenge response comprising a beacon value obtained based on a radio beacon signal received by the mobile computing device; determining that the beacon value matches an expected beacon value; and based on the determining, permitting the action.

### FIELD OF THE DISCLOSURE

The present disclosure relates to the determination of a location of a device to enable or disable computing functionality.

### BACKGROUND

In some cases, a system may require a mobile device to be in a particular location in order for an action to be performed. However, such location can often be faked at the device, bypassing the system's requirements.

### SUMMARY

In accordance with the embodiments of the present disclosure, a system may require that a computing device such as a mobile device be at a particular location prior to allowing an action from such device.

In one aspect, a computer method may be provided. The computer method may include sending a location challenge to a mobile computing device, the location challenge identifying a radio beacon, and receiving a location challenge response from the mobile computing device, the location challenge response comprising a beacon value obtained based on a radio beacon signal received by the mobile computing device. The computer method may further include determining that the beacon value matches an expected beacon value, and based on the determining, permitting the action.

In some embodiments, the method may further comprise sending a second location challenge to a second mobile computing device, the second location challenge identifying the radio beacon, and receiving a second location challenge response from the mobile computing device, the second location challenge response comprising a second beacon value. The method may further comprise determining that the second beacon value does not match the expected beacon value, and based on the determining, denying the action.

In some embodiments, the beacon value may comprise data within the radio beacon.

In some embodiments, the radio beacon may be a Bluetooth or a Bluetooth Low Energy beacon.

In some embodiments, the beacon value may comprise a major value and minor value transmitted within the radio beacon.

In some embodiments, the radio beacon may be a Wi-Fi signal.

In some embodiments, the location challenge response may comprise a plurality of beacon values, each associated with a received signal strength, and wherein the determining may use triangulation to find a location of the remote computing device.

In some embodiments, the location challenge response may comprise a received signal strength, and wherein the determining may further find whether the received signal strength is greater than a threshold.

In some embodiments, the expected beacon value may change at defined time intervals.

In some embodiments, the expected beacon value may be based on a rolling code.

In some embodiments, the rolling code may use at least one of a Pseudorandom Number Generator (PRNG) and a Hash-Based Message Authentication Code (HMAC) based one-time password.

In some embodiments, the location challenge response may comprise a plurality of beacon values, each coming from a radio beacon signal having an identifier identified in the location challenge.

In some embodiments, the first computing device is a server associated with an electronic commerce platform, and wherein the action is a location gated sale of a product or service.

In some embodiments, the determining may be performed both during access to the product or service, and at checkout for the product or service.

In a further aspect, a computer system comprising a processor and a communications subsystem may be provided. The computer system may be configured to send a location challenge to a mobile computing device, the location challenge identifying a radio beacon, and receive a location challenge response from the mobile computing device, the location challenge response comprising a beacon value obtained based on a radio beacon signal received by the mobile computing device. The computing system may further be configured to determine that the beacon value matches an expected beacon value, and based on the determining, permit the action.

In some embodiments, the computer system may further be configured to send a second location challenge to a second mobile computing device, the second location challenge identifying the radio beacon; receive a second location challenge response from the mobile computing device, the second location challenge response comprising a second beacon value; determine that the second beacon value does not match the expected beacon value; and based on determining that the second beacon value does not match the expected beacon value, deny the action.

In some embodiments, the beacon value may comprise data within the radio beacon.

In some embodiments, the radio beacon may be a Bluetooth or a Bluetooth Low Energy beacon.

In some embodiments, the beacon value may comprise a major value and minor value transmitted within the radio beacon.

In a further aspect, a computer readable medium for storing instruction code may be provided. The instruction code, when executed by a processor of a computer system, may cause the computer system to send a location challenge to a mobile computing device, the location challenge identifying a radio beacon, and receive a location challenge response from the mobile computing device, the location challenge response comprising a beacon value obtained based on a radio beacon signal received by the mobile computing device. The instruction code, when executed by a processor of the computer system, may cause the computer system to determine that the beacon value matches an expected beacon value, and based on the determining, permit the action.

### BRIEF DESCRIPTION OF THE DRAWINGS

The present disclosure will be better understood with reference to the drawings, in which:

FIG. 1 is a block diagram showing a system for determining that a computing device is at a desired location.

FIG. 2 is a dataflow diagram showing the permitting of a location gated action when a beacon identifier is found at a desired location.

FIG. 3 is a dataflow diagram showing the permitting of a location gated action when a beacon identifier is found from a server.

FIG. 4 is a dataflow diagram showing the permitting of a location gated action when using a location gating server.

FIG. 5 is a block diagram showing a simplified computing device capable of being used with the embodiments of the present disclosure.

### DETAILED DESCRIPTION

The present disclosure will now be described in detail by describing various illustrative, non-limiting embodiments thereof with reference to the accompanying drawings. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

In accordance with the embodiments of the present disclosure, a system may require that a computing device such as a mobile device be at a particular location prior to allowing an action from such device. For example, in a scavenger hunt or an orienteering race, a participant may need to get to a particular location prior to receiving a clue or being permitted to go to the next checkpoint.

In other cases, a venue for a sporting match or concert may offer exclusive merchandise or prizes to those in attendance.

In other cases, augmented reality games may occur in the real world and require a participant to be at a particular location to participate in part of the game.

In other cases, a Non-Fungible Token (NFT) may be gated and require a proof of attendance to obtain the NFT.

Other options are possible.

However, in all these cases, the location of the computing device can be faked. For example, existing systems use Global Positioning System (GPS) coordinates as reported by a user's smartphone. These coordinates can easily be falsified if the location required by the system is known, allowing a user to trick the system to permit them to meet the requirements for being at that location. Further, the location may in some cases be a static location, making it easy to fake the location. For example, a sporting venue will have a location that can easily be determined and spoofed by a user.

In other cases, locations may be posted to social media or on the Internet, and again the location of the computing device can be faked based on information mined from such sites.

Thus, in accordance with embodiments of the present disclosure, the use of second location verification in addition to or instead of GPS may be used for location verification.

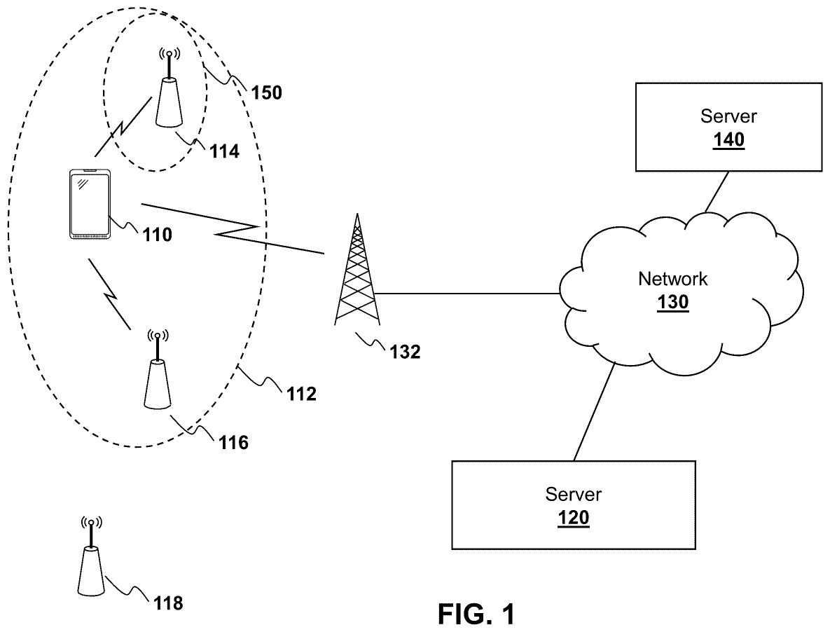

Reference is now made to FIG. 1. In the embodiment of FIG. 1, a computing device 110 may be required to be in a particular location 112 in order to complete a computing function or action. For example, computing device 110 may be a mobile device, laptop computer, desktop computer, portable computing device, smartphone, among others.

Computing device 110 may in some cases include a first positioning sensor to report its position. In practice, a first positioning sensor may use a positioning subsystem such as a Global Navigation Satellite System (GNSS) receiver which may be, for example, a Global Positioning System (GPS) receiver (e.g. in the form of a chip or chipset) for receiving GPS radio signals transmitted from one or more orbiting GPS satellites. References herein to “GPS” are meant to include Assisted GPS and Assisted GPS. Although the present disclosure refers expressly to the “Global Positioning System”, it should be understood that this term and its abbreviation “GPS” are being used expansively to include any GNSS or satellite-based navigation-signal broadcast system, and would therefore include other systems used around the world including the Beidou (COMPASS) system being developed by China, the multi-national Galileo system being developed by the European Union, in collaboration with China, Israel, India, Morocco, Saudi Arabia and South Korea, Russia's Global Navigation Satellite System (GLONASS), India's proposed Regional Navigational Satellite System (IRNSS), and Japan's proposed Quasi-Zenith Satellite System (QZSS) regional system, among others.

However, as indicated above, the first positioning sensor may in some cases be spoofed when attempting to perform the computing function or action. For example, if location 112 is known or if location 112 has been published, then computing device 110 may be able to perform the computing function or action by spoofing such known location information in a request, bypassing location controls.

Therefore, in some embodiments, the computing device 110 may have a secondary positioning sensor. In some cases, the secondary positioning sensor may be a receiver that can receive short-range transmission signals. For example, the secondary positioning sensor may be a Bluetooth™ receiver that can receive Bluetooth or Bluetooth Low Energy (BLE) Advertisements/beacons. However, in other cases the receiver could be a Wi-Fi™ receiver that receives Wi-Fi beacons, advertisements or other signals. In other cases, it could be a Near Field Communications (NFC) receiver that could receive NFC signals. In other cases, it could be an Ultra-wideband (UWB) radio receiver or another wireless personal area network or wireless local area network that supports transmitting advertisements or beacons. Other options are possible.

In the example of FIG. 1, two transmitters, namely transmitter 114 and transmitter 116, may be within location 112 and may transmit radio beacons that may be read by computing device 110. While the example of FIG. 1 shows two transmitters 114 and 116 within a location, in some cases only a single beacon transmitter may be used at a location. In some cases, more than two beacon transmitters may be used, especially when location 112 is large, such as a sports arena, mall, or stadium.

Further, as described below, in some cases, one or more transmitters 118 may be located outside location 112, and may transmit “honeypot” signals to find if computing device 110 is outside location 112.

In the case that transmitters 114, 116 transmit Bluetooth beacons, such beacon signals may take various forms. For example, the beacon signal could be an iBeacon, which is a Bluetooth protocol created by Apple™. In some cases, the beacon may be an AltBeaon, URIBeacon, or Eddystone beacon. Other radio beacon options are possible.

While these beacon signals may have slight differences, in each case they may have values associated therewith, where such values can be set or defined by an administrator. For example, the iBeacon standard has a major and minor values in data fields that are transmitted. Such values in the radio beacon signal can be set or changed as needed. Wi-Fi advertisements, Bluetooth advertisements/beacons, UWB and NFC similarly allow for an identifier or other protocol field where the value can be set by an administrator and transmitted.

Thus, in some cases the secondary positioning sensor may be based on receipt of a signal from a beacon or other short-range transmission. In some cases, the radio beacon signal may be transmitted from a transmitter having a Universally Unique Identifier (UUID), where such UUID may be identified to the computing device 110 through an input mechanism. While UUID is used herein, and could be in a standardized 128-bit numerical form or 36-character alphanumeric form, any transmitter identifier for a short-range transmitter could be used. This could include numerical or text identifiers.

Further, while the term “secondary positioning sensor” is used herein, in some cases this may be the only position determination sensor on a computing device, and the present disclosure is therefore not limited to the computing device 110 having a GPS or other positioning sensor.

Using the computing device 110, in one example at a location 112 that the user is to perform location verification, the UUID may be presented to the computing device 110. This may be in the form of a Quick Response (QR) code, which could be scanned by the computing device 110, where the QR code will direct the computing device to an address (e.g. a Uniform Resource Locator (URL)), which could return the UUID.

For example, in FIG. 1, a computing device 110 may scan a QR code which provides a URL for a server 120. The computing device 110 may query server 120 for beacon identifiers to range for. Such query may be over a network 130 such as the Internet, for example through an access point 132. Access point 132 may be any access point that a computing device 110 may be capable of using for communications, including, but not limited to, any Third Generation Partnership Project (3GPP) base station, Wi-Fi access point, ethernet connection, non-terrestrial access point, among others.

In some cases, a server 120 (accessed using the address or URL), can make a choice to respond to a request from the computing device 110 with a gate or location challenge, or may respond with something else that may not have a gate. If the server 120 provides a response with a gate challenge, the server may further send a UUID and further may in some cases choose which UUID to send.

In effect, the use of a link to get the UUID allows dynamic functionality by allowing gating to start at the time of the request, or for one of a plurality of responses to be sent and helps prevent the UUIDs being known in advance.

In other cases, the UUID could be part of the QR code.

In other cases, the UUID (or the link to get the UUID) could be part or a barcode, part of display which the computing device 110 could interpret using text detection or could be entered manually into the computing device 110 by a user using a user interface, among other options.

Once the computing device 110 has the UUID, the computing device could listen for signals having such UUID, for example from transmitters 114 and 116, and could then find the values from such radio signal. One example of such values is the major and minor values of an iBeacon. In the case where the beacon format has more than one field, the field values can be set, read, transmitted and validated independently, or combined in a way to provide more bits of entropy and set, read, transmitted and validated together.

When the computing device 110 has the beacon values, it can provide these in a request to the system for the action to be performed. For example, such request to the system could be to a server 120 in some cases. In some cases, such request could be to a different server 140. In some cases, such request could include a primary location identification as well, for example from a GPS chipset at the computing device 110.

For example, in a scavenger hunt situation, the organizer may have set up a transmitter 114 at the location 112. A user arriving at that location may scan a QR code with computing device 110 to get the UUID of the transmitter and listen for radio beacon signals. Once the computing device 110 detects the beacon signal with the UUID, it can find values from the beacon signal (e.g. major and minor values), and provide these in a request to a server 120 to get the next clue. In some cases, these values can be provided along with GPS coordinates.

Similarly, at a concert, an organizer may display a UUID and the user could input such UUID into an application on her mobile device. Input in this case could be through any input means, including a keyboard, keypad, camera, among others. The mobile device could listen for a radio signal with the UUID from a transmitter 116, and the mobile device could find the beacon value from the radio signal. The user could then request the purchase of merchandise exclusively available to the participants at the concert using the values within the radio beacon signal from a server 140.

In yet another example, a retail store's Point of Sale system may publish beacon signals with a UUID that a mobile device is listening for in the background. The mobile device would use the device location (i.e. using the secondary positioning to trigger confirmation using primary positioning) to confirm the user's location to then unlock in store products exclusive to them.

The values set in the beacon signal could be exclusive to an event. For example, with the concert scenario, the organizers could activate the transmitters 114, 116 to send beacon signals with values uniquely set for that day, ensuring that information observed from beacon signals during previous shows, even if posted online, would not allow someone access to the rewards or merchandise unless they were physically present.

Further, in some cases the value from the beacon signal could be changed manually or automatically, for example after a defined time interval. The server 120 would know about the changing values and would ensure that only those providing the most recent values can cause the action to be initiated.

For example, the server 120 may know the timestamp of both when the initial Request came in (and its Response (UUID) went out), and when the “values” are received. The server 120 may use this to know what “values” are valid between when the response with the UUID went out and when the challenge response was received. In this case, if the time between these two events is too long or too short, such information may be used to infer security information and deny access to the gated action.

In some cases, the values may be a rolling code or hopping code, which may prevent a replay attack. For example, the transmitter 114 of the beacon and the server 120 may both use a pseudorandom number generator with a shared seed to generate the value, where the server 120 could then compare the value received from the computing device 110 with an expected next value in a sequence. As will be appreciated, this would then prevent the beacon value from being used again, as the beacon value would not be repeated, thereby further preventing spoofing of the location.

For example, such rolling code may include a counter value and a unique code computed using the pseudorandom number generator. Based on the counter value, the server 120 could determine whether the unique code is valid. Other examples are possible. The seed may be synchronized between the beacon transmitter 114, 116 and server 120 in a secure manner. Further, each of transmitters 114 and 116 may use different seeds in some cases, and the server 120 may use information such as the UUID to determine which transmitter sent the unique code in order to perform the validation.

In some cases, the rolling code may use a Hash-Based Message Authentication Code (HMAC) with a shared key.

In some cases, other time-based one-time password (TOTP) algorithms may be used.

In some cases, a sequence of values and time for changing the values may be known at both the transmitter and server. For example, a timestamp and value array may be shared between the transmitters and servers in some cases.

Other options are possible.

In some cases, a venue or location 112 may have a plurality of transmitters 114, 116 transmitting beacon signals. In this case, in one embodiment all the beacon signals may have the same UUID, and thus the report could include all the values heard from the beacon signals with the UUID.

In other cases, the scanning of the QR code could cause a plurality of UUIDs to be provided to the computing device 110, and in this case the device may listen for beacons having any of the enumerated UUIDs.

In some cases, when a plurality of transmitters 114, 116 of beacon signals are present, signal strength may be reported to the server 120 to allow triangulation to occur.

In some cases, the transmitters 114, 116 of the beacon signals could be placed so that their signal could only be received within the confines of the venue or desired location 112.

In some cases, transmitters 118 of beacon signals having the UUID but located outside of the venue or location 112 could be used as “honeypot” beacon signals to indicate that the computing device 110 is not within the location 112, and thus the action should not be performed.

In other cases, nested desired locations may be possible. For example, at a concert venue, those in the general location 112 may be entitled to certain rewards, but those in a VIP area 150 may be entitled to different rewards. The areas may be differentiated by having different UUIDs for transmitters 114 and 116 in some cases. The areas may be differentiated by having transmitters 114 and 116 have the same UUID, but sending different data, such as different major and minor values set in some cases. Other options are possible. In such situation, the computing device 110 may be unable to receive a beacon from transmitter 114 when outside area 150.

Other options are possible.

Examples of such various options are shown with regard to the drawings.

### Providing the UUID at the Location

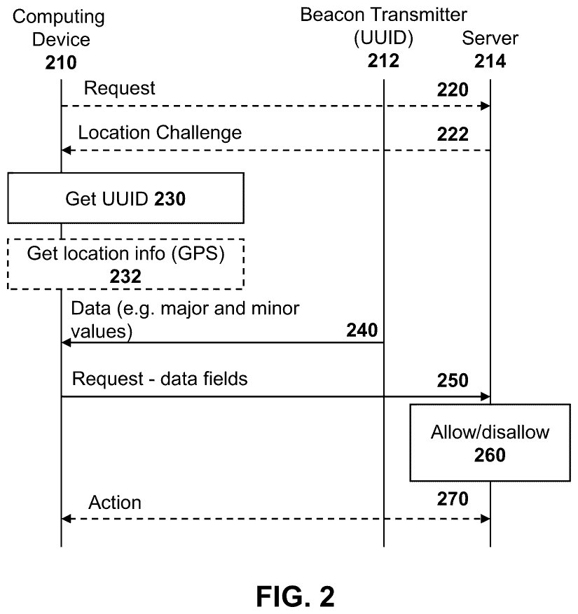

Referring to FIG. 2, in one embodiment the UUID information may be found at the designated location.

Thus, in the example of FIG. 2, a computing device 210 may optionally provide a request 220 to server 214 requesting that an action be performed. Server 214 may determine that the action is location gated, and may therefore provide a location challenge 222 back to computing device 210, indicating that the computing device must provide certain proof of location in order for the action to be performed.

As will be appreciated by those skilled in the art, request 220 and challenge 222 are optional, and in some cases computing device 210 will know that the action is a location gated action and therefore skip directly to obtaining the proof of location.

In the embodiments herein, a proof of location may be receipt of data or information within certain radio beacons. These certain radio beacons may be identified with a UUID in some cases.

For example, such UUID information may be part of a QR code, barcode, or other code at the venue that may be scanned by a computing device 210. For example, such scanning may use a camera on the computing device 210.

In other cases, the UUID may be displayed in plaintext, and image recognition software at the computing device 210 may be used to analyze a picture taken of such plaintext UUID.

In other cases, the UUID may be broadcast through a short range communications technology, such as a Radio Frequency Identification (RFID) system that a user can scan using computing device 210 at the location.

In some cases, the UUID may be manually input, for example into an application on computing device 210.

Other techniques for obtaining the UUID are possible.

Thus, in the embodiment of FIG. 2, the computing device may obtain the UUID at block 230.

Further, in some cases the computing device may optionally obtain a location from a positioning system such as GPS, shown at block 232.

Once the UUID is determined, the computing device 210 could then listen for radio beacons from a beacon transmitter 212 having that UUID. While the embodiment of FIG. 2 shows only a single beacon transmitter 212, in practice a plurality of beacon transmitters may be used in some cases. Such plurality of beacon transmitters may use the same UUID in some cases, or may use different UUIDs in some cases. If using different UUIDs, the getting of the UUID at block 230 may result in the plurality of UUIDs being obtained by computing device 210.

The computing device 210 could then listen for and receive a radio beacon signal 240 having a beacon value therein. For example, the beacon value could include the major and minor values for an iBeacon. The beacon value could therefore be a secret that is provided by the transmitter in order to ensure the computing device is at the desired location.

Further, if computing device 210 can detect multiple radio beacon signals, each having a UUID identified at block 230, then computing device 210 could make note of all the beacon values within such signals.

Further, while the example of FIG. 2 uses a UUID, in some cases other identifiers could be used. For example, if the radio beacon is a Wi-Fi beacon, then the Service Set Identifier (SSID) could be used. Other options are possible. Thus, the use of a UUID with regard to FIG. 2 is merely provided for illustrative purposes.

Computing device 210 could then send a location challenge response 250 back to server 214 providing the beacon values detected from radio beacons having the identified UUID.

Upon receiving the location challenge response 250, server 214, at block 260 may determine whether to permit the action or not. For example, the server 214 may determine whether the data fields or beacon values found within the location challenge response 250 match the expected beacon values. Such expected beacon values could be the values set for that day to be transmitted by the beacon transmitter 212 in some cases. If the value sent from beacon transmitter 212 is a changing value, then the server 214 could determine whether the expected value is received from the computing device 210.

In some cases, timestamps found within the location challenge response 250 could determine whether the beacon values are recent enough.

In some cases, the difference between the location challenge 222 send time and the location challenge response 250 receive time may need to be under a threshold in order to allow the action.

In some cases, the beacon values may further be provided with beacon signal strengths, and the check at block 260 may determine where the device is more precisely by using such signal strengths to find a more precise location. In some cases, this may involve knowing a beacon transmitter 212 radio transmission strength and using a Received Signal Strength Indicator (RSSI) to determine the distance from the transmitter. Here, the RSSI may need to be greater than a threshold or the distance less than a threshold to permit the action.

In some cases, the check at block 260 may find that multiple beacon signals were received by computing device 210, and the respective signal strengths for each of the beacon signals may be used to triangulate the location of the computing device.

In some cases, the check at block 260 may further determine what action is permitted. Specifically, certain locations may allow some actions while other locations allow other actions. For example, within a concert venue, those in a first section may have permission to perform first actions, while those in a second section may have permission to perform second actions.

In some cases, the GPS location data as found at block 232 and provided in request 250 may be one factor in the determination on whether to allow or disallow the action. For example, if the beacon values match those expected by server 214, but the GPS location differs from the expected value, this may indicate that computing device 210 is trying to spoof the location, and the action may be disallowed.

Other options are possible.

If, at block 260, it is determined that the action (and which action) is permitted, then the action 270 could be performed. For example, the action 270 may be to provide the next clue in an orienteering race or scavenger hunt. The action 270 may be to permit the purchase of exclusive merchandise for participants in an event in some cases. The action 270 may be to provide awards to an event participant in some cases.

Further, in some cases the location challenge response 250 and the check at block 260 could be performed multiple times. For example, if purchasing products exclusively available to participants of an event, the check could be performed both at the time that the product is placed into a shopping cart and during a checkout procedure. Other examples of multiple checks are possible.

Conversely, at block 260 it may be determined that the action should not be permitted. A message may be sent to computing device 210 indicating that the action is denied in some cases.

### Providing a URL to Get a UUID at the Location

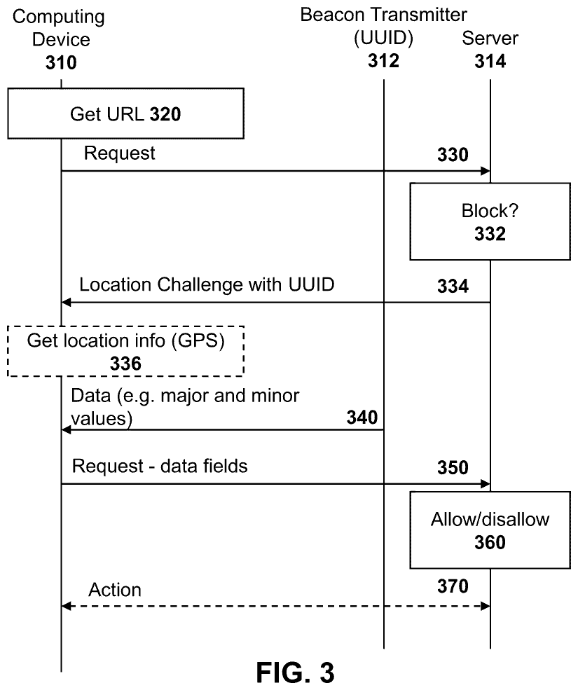

In a further embodiment, rather than providing the UUID at the location, a URL or other address may be provided at the location to obtain the UUID. For example, in some cases, materials may need to be printed ahead of time or may be used again over multiple days or at multiple venues. In this case, having the UUID as part of a barcode or QR code could be limiting. In this case, rather than having the UUID as part of the material at the venue, an address to get a unique identifier could be provided instead. Reference is now made to FIG. 3.

Thus, in the example of FIG. 3, a proof of location may be the receipt of data or information within certain radio beacons. These certain radio beacons may be identified with a UUID in some cases. However, to avoid having a pre-defined UUID at a location, instead the UUID may be provided from a network element such as a server 314.

A computing device 310 may therefore, at block 320, obtain a URL or other address for server 314. For example, such URL information may be part of a QR code, barcode, or other code at the venue that may be scanned by a computing device 310. For example, such scanning may use a camera on the computing device 310.

In other cases, the URL may be displayed in plaintext, and image recognition software at the computing device 310 may be used to analyze a picture taken of such plaintext URL.

In other cases, the URL may be broadcast through a short range communications technology, such as a Radio Frequency Identification (RFID) system that a user can scan using computing device 310 at the location.

In other case, the URL may be manually input into computing device 310 using a user interface at computing device 310.

Other techniques for obtaining the URL are possible.

Once the URL is obtained, a computing device 310 may provide a request 330 to server 314 requesting that an action be performed.

In some cases, the server 314 may receive request 330 and based on information within the request, may block the request at block 332. Specifically, if data within the request indicates that the message came from a location other than the venue or desired location, the blocking may occur at block 332. For example, the request may have an Internet Protocol (IP) address or path data which may indicate which network nodes, base stations, access points or other elements the request was passed through, among other such information, which may indicate that the request originated from somewhere other than the desired location.

However, the check at block 332 is optional and in some cases does not need to be provided.

If block 332 disallows the request, a response without a gating function may be provided to computing device 310. For example, the response may redirect the computing device to a site that is not location gated, among other options.

If block 332 is passed, or if block 332 is not part of the system, server 314 may determine that the action is location gated, and may therefore provide a location challenge 334 back to computing device 310, indicating that the computing device must provide certain proof of location in order for the action to be performed. The location challenge 334 may include an identifier for a radio beacon, such as a UUID.

In some cases, the computing device 310 may optionally obtain a location from a positioning system such as GPS, shown at block 336.

Once the UUID is received, the computing device 310 could then listen for radio beacons from a beacon transmitter 312 having that UUID. While the embodiment of FIG. 3 shows only a single beacon transmitter 312, in practice a plurality of beacon transmitters may be used in some cases. Such plurality of beacon transmitters may use the same UUID in some cases, or may use different UUIDs in some cases. If using different UUIDs, challenge 334 may provide the plurality of UUIDs to computing device 310.

The computing device 310 could then listen for and receive a radio beacon signal 340 having a beacon value therein. For example, the beacon value could include the major and minor values for an iBeacon. The beacon value could therefore be a secret that is provided by the transmitter to ensure the computing device is at the desired location.

Further, if computing device 310 can detect multiple radio beacon signals, each having a UUID identified in challenge 334, then computing device 310 could make note of all the beacon values within such signals.

Further, while the example of FIG. 3 uses a UUID, in some cases other identifiers could be used. For example, if the radio beacon is a Wi-Fi beacon, then the Service Set Identifier (SSID) could be used. Other options are possible. Thus, the use of a UUID with regard to FIG. 3 is merely provided for illustrative purposes.

Computing device 310 could then send a location challenge response 350 back to server 314 providing the beacon values detected from radio beacons having the identified UUID.

Upon receiving the location challenge response 350, server 314, at block 360 may determine whether to permit the action or not. For example, the server 314 may determine whether the data fields or beacon values found within the location challenge response 350 match the expected beacon values. Such expected beacon values could be the values set for that day to be transmitted by the beacon transmitter 312 in some cases. If the value sent from beacon transmitter 312 is a changing value, then the server 314 could determine whether the expected value is received from the computing device 310.

In some cases, timestamps found within the location challenge response 350 could determine whether the beacon values are recent enough.

In some cases, the difference between the location challenge 334 send time and the location challenge response 350 receive time may need to be within a threshold in order to allow the action. For example, if the time between the location challenge 334 send time and the location challenge response 350 receive time is too long or too short, this may be used to infer security information and deny the gate.

In some cases, the beacon values may further be provided with beacon signal strengths, and the check at block 360 may determine where the device is more precisely by using such signal strengths to find a more precise location. In some cases, this may involve knowing a beacon transmitter 312 radio transmission strength and using a Received Signal Strength Indicator (RSSI) to determine the distance from the transmitter. Here, the RSSI may need to be greater than a threshold or the distance less than a threshold to permit the action.

In some cases, the check at block 360 may find that multiple beacon signals were received by computing device 310, and the respective signal strengths for each of the beacon signals may be used to triangulate the location of the computing device.

In some cases, the check at block 360 may further determine what action is permitted. Specifically, certain locations may allow some actions while other locations allow other actions.

In some cases, the GPS location data as found at block 336 and provided in request 350 may be one factor in the determination on whether to allow or disallow the action. For example, if the beacon values match those expected by server 314, but the GPS location differs from the expected value, this may indicate that computing device 310 is trying to spoof the location, and the action may be disallowed.

Other options are possible.

If, at block 360, it is determined that the action (and what action) is permitted, then the action 370 could be performed. For example, the action 370 may be to provide the next clue in an orienteering race or scavenger hunt. The action 370 may be to permit the purchase of exclusive merchandise for participants in an event in some cases. The action 370 may be to provide awards to an event participant in some cases.

Further, in some cases the location challenge response 350 and the check at block 360 could be performed multiple times. For example, if purchasing products exclusively available to participants of an event, the check could be performed both at the time that the product is placed into a shopping cart and during a checkout procedure. Other examples of multiple checks are possible.

Conversely, at block 360 it may be determined that the action should not be permitted. A message may be sent to computing device 310 indicating that the action is denied in some cases.

### Multiple Servers

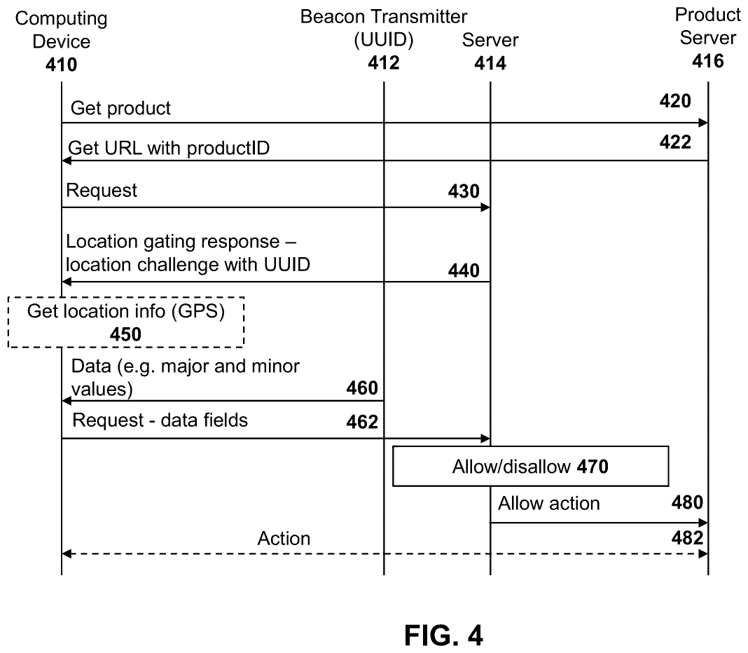

Reference is now made to FIG. 4 which shows a computing device 410 that may be used by a user. Computing device 410 can, in some cases, be a mobile device, and may be referred to as a cellular telephone, a portable data device, a laptop, a smartphone, among other options.

The system may further include one or more short range transmitters, such as beacon transmitter 412.

The system may further include a server 414. Server 414 may be any computing device capable of performing location gatekeeping actions.

The system may further include a server 416. Server 416 may be any computing device capable of performing the location gated actions. For example, in FIG. 4, server 416 may be an ecommerce platform or store that may allow sales of products to those at a particular location.

In the example of FIG. 4, the computing device is trying to get a product from server 416, as shown with message 420. However, when the user, using computing device 410, tries to get the product, instead the device may get instructions 422 to scan a QR code or may provide a URL to interact with server 414, among other options. Instructions 420 may have a product ID used for the interaction with server 414 in some cases.

Computing device 410 may then interact with server 414 with message 430. Message 430 may for example include a product identifier, an identifier for server 416, among other information.

In some cases, server 414 may check the routing of message 430, for example the sender IP address, to determine whether the address makes sense with regard to the required location. However, such check is optional.

In some cases, server 414 may make a decision about whether to respond to message 430 and with what information. This may involve whether to send a location gating response or not, and if a location gating response is sent, the server 414 may choose which UUID to respond with, among other options. In some cases such response may be based on the product identifier and/or the server in request 430.

Server 414 may return, in message 440, a location gating response having a location challenge with at least one UUID.

While the example of FIG. 4 shows the UUID being obtained based on a query to a server 414, in some cases the UUID may be displayed or provided at the location itself, rather than needing to be obtained from server 414, as with the example of FIG. 1. Thus message 430 and message 440 may be optional in some cases.

Based on receipt of the location gating challenge, the computing device 410 may in some cases determine its location, for example with a GPS transceiver, as shown at block 450.

The computing device 410 may further listen for beacon signals with a UUID (e.g. as identified from message 440 or based on information at the venue, among other options). The radio beacon signal is shown with message 460, and includes, for example, the major and minor values assigned to the beacon, which would be known to the server 414. The beacon value could therefore be a secret that is provided by the transmitter to ensure the computing device is at the desired location.

In some cases, message 460 may further include a transmitted signal strength.

In some cases, message 460 may further include other information. For example, some beacon signals may allow a small payload beyond the identifier values, and such payload may be set to a value known by the server 414. Other options are possible.

Once message 460 is received, computing device 410 could find the values and other information within the message and then make a request 462 to server 414. Request 462 could include, for example, the product ID (or application identifier, service identifier or other identifier for the action the user is interested in), along with information from the beacon signals, and in some cases from the first positioning system. Such data may include the major and minor values from the beacon, for example. In some cases, such data may include the latitude and longitude from a GPS receiver. Other information within message 462 is possible.

If the values in the beacon signal change, request 462 could include the latest values to ensure that the computing device 410 is still at the location.

In some cases, other information may further be provided in request 462. For example, this may include the received signal strength of the beacon signal, an approximate distance based on the computing device making calculations from the transmitted signal strength, an array of major/minor values seen with for the UUID(s), information from fields in the beacon, among other information.

Based on receiving message 462, the server 414 could evaluate the information in the message and allow or disallow the action at block 470. Further, in some cases the check at block 470 may further determine what action is permitted. Such check could be similar to the check at blocks 260 and 360 from FIGS. 2 and 3 respectively.

For example, if the primary location and values from the beacon signal match the required location, then the action may be allowed. Such action may be the provision of a location gating acceptance in message 480 to product server 416 to permit purchase of the merchandise. Message 480 may further indicate what action is permitted.

Based on gating approval, the action 482 is shown to take place. While the action in the embodiment of FIG. 4 is the sale of a product that is location gated, other actions such as providing clues for a scavenger hunt, allowing the purchase of an NFT out a particular location as such as a museum, among other actions are possible.

In some cases, with products, the location can be a gate for both product selection and for checkout, and thus two separate checks may be made at block 470.

Conversely, if the location and/or beacon values do not match the desired location, then the server 414 could block the action.

### Computing Device

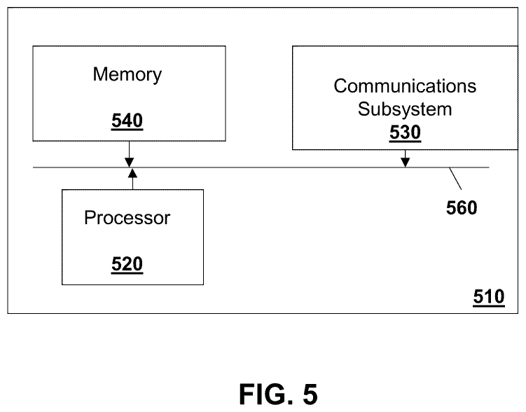

The above-discussed methods are computer-implemented methods and require a computer for their implementation/use. Such computer system could be implemented on any type of, or combination of, network elements, servers, or computing devices. For example, one simplified computing device that may perform all or parts the embodiments described herein is provided with regard to FIG. 5.

In FIG. 5, computing device 510 includes a processor 520 and a communications subsystem 530, where the processor 520 and communications subsystem 530 cooperate to perform the methods of the embodiments described herein.

The processor 520 is configured to execute programmable logic, which may be stored, along with data, on the computing device 510, and is shown in the example of FIG. 5 as memory 540. The memory 540 can be any tangible, non-transitory computer readable storage medium, such as dynamic random access memory (DRAM), Flash, optical (e.g., compact disc (CD), Digital Video Disc (DVD), etc.), magnetic (e.g., tape), flash drive, hard drive, or other memory known in the art. In one embodiment, processor 520 may also be implemented entirely in hardware and not require any stored program to execute logic functions. Memory 540 can store instruction code, which, when executed by processor 520 cause the computing device 510 to perform the embodiments of the present disclosure.

Alternatively, or in addition to the memory 540, the computing device 510 may access data or programmable logic from an external storage medium, for example through the communications subsystem 530.

The communications subsystem 530 allows the computing device 510 to communicate with other devices or network elements. In some embodiments, communications subsystem 530 includes receivers or transceivers, including, but not limited to, ethernet, fiber, Universal Serial Bus (USB), cellular radio transceiver, a Wi-Fi transceiver, a Bluetooth transceiver, a Bluetooth low energy transceiver, a GPS receiver, a satellite transceiver, an IrDA transceiver, among others. As will be appreciated by those in the art, the design of the communications subsystem 530 will depend on the type of communications that the computing device is expected to participate in.

Communications between the various elements of the computing device 510 may be through an internal bus 560 in one embodiment. However, other forms of communication are possible.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer method comprising:
sending a location challenge to a mobile computing device, the location challenge identifying a radio beacon;
receiving a location challenge response from the mobile computing device, the location challenge response comprising a beacon value obtained based on a radio beacon signal received by the mobile computing device;
determining that the beacon value matches an expected beacon value; and
based on the determining, permitting an action.

2. The method of claim 1, further comprising:
sending a second location challenge to a second mobile computing device, the second location challenge identifying the radio beacon;
receiving a second location challenge response from the mobile computing device, the second location challenge response comprising a second beacon value;
determining that the second beacon value does not match the expected beacon value; and
based on the determining, denying the action.

3. The computing method of claim 1, wherein the beacon value comprises data within the radio beacon.

4. The computing method of claim 1, wherein the radio beacon is a Bluetooth or a Bluetooth Low Energy beacon.

5. The computing method of claim 4, wherein the beacon value comprises a major value and minor value transmitted within the radio beacon.

6. The computing method of claim 1, wherein the radio beacon is a Wi-Fi signal.

7. The computing method of claim 1, wherein the location challenge response comprises a plurality of beacon values, each associated with a received signal strength, and wherein the determining uses triangulation to find a location of the mobile computing device.

8. The computing method of claim 1, wherein the location challenge response comprises a received signal strength, and wherein the determining further finds whether the received signal strength is greater than a threshold.

9. The computing method of claim 1, wherein the expected beacon value changes at defined time intervals.

10. The computing method of claim 9, wherein the expected beacon value is based on a rolling code.

11. The computing method of claim 10, wherein the rolling code uses at least one of a Pseudorandom Number Generator (PRNG) and a Hash-Based Message Authentication Code (HMAC) based one-time password.

12. The computing method of claim 1, wherein the location challenge response comprises a plurality of beacon values, each coming from a radio beacon signal having an identifier identified in the location challenge.

13. The computing method of claim 1, wherein the method is performed by a server associated within an electronic commerce platform, and wherein the action is a location gated sale of a product or service.

14. The computing method of claim 13, wherein the determining is performed both during access to the product or service, and at checkout for the product or service.

15. A computer system comprising:
a processor; and
a communications subsystem,
wherein the computer system is configured to:
send a location challenge to a mobile computing device, the location challenge identifying a radio beacon;
receive a location challenge response from the mobile computing device, the location challenge response comprising a beacon value obtained based on a radio beacon signal received by the mobile computing device;
determine that the beacon value matches an expected beacon value; and
based on determining that the beacon value matches the expected beacon value, permit an action.

16. The computer system of claim 15, wherein the computer system is further configured to:
send a second location challenge to a second mobile computing device, the second location challenge identifying the radio beacon;
receive a second location challenge response from the mobile computing device, the second location challenge response comprising a second beacon value;
determine that the second beacon value does not match the expected beacon value; and
based on determining that the second beacon value does not match the expected beacon value, deny the action.

17. The computer system of claim 15, wherein the beacon value comprises data within the radio beacon.

18. The computer system of claim 15, wherein the radio beacon is a Bluetooth or a Bluetooth Low Energy beacon.

19. The computer system of claim 18, wherein the beacon value comprises a major value and minor value transmitted within the radio beacon.

20. A computer readable medium for storing instruction code, which, when executed by a processor of a computer system cause the computer system to:
send a location challenge to a mobile computing device, the location challenge identifying a radio beacon;
receive a location challenge response from the mobile computing device, the location challenge response comprising a beacon value obtained based on a radio beacon signal received by the mobile computing device;
determine that the beacon value matches an expected beacon value; and
based on determining that the beacon value matches an expected beacon value, permit the action.
